(19) United States
(12) Patent Application Publication
(10) Pub. No.: US 2026/0166970 A1
(43) Pub. Date: Jun. 18, 2026

(54) Air Conditioner and Motor Vehicle With Such an Air Conditioner

(71) Applicant: MAHLE International GmbH, Stuttgart (DE)

(72) Inventor: Holger Laux, Dietingen (DE)

(21) Appl. No.: 19/418,641

(22) Filed: Dec. 12, 2025

(30) Foreign Application Priority Data
Dec. 16, 2024 (DE) 102024137896.4

(51) Int. Cl. B60H 3/02; B60H 3/06

(52) U.S. Cl. CPC B60H 3/024; B60H 3/0608

(57) ABSTRACT

An air conditioner for a motor vehicle is provided. The air conditioner contains at least the following components: a fresh air channel and a recirculating air channel, as well as a downstream mixed air channel, a fan for conveying the mixed air in the mixed air channel, an evaporator for cooling the mixed air in the mixed air channel, a heater for heating the mixed air in the mixed air channel, a dehumidifier for dehumidifying recirculated air in the recirculating air channel, and at least one filter downstream of the dehumidifier in the mixed air channel.

### CROSS-REFERENCE TO RELATED APPLICATIONS

This application claims priority from German Patent Application No. DE 102024137896.4, filed on Dec. 16, 2024, the entirety of which is hereby incorporated by reference herein.

The present invention relates to an air conditioner for a motor vehicle according to the preamble of Numbered Paragraph 1. The invention also relates to a motor vehicle that has such an air conditioner.

When air conditioning passenger a compartment, in particular in electric vehicles, it is preferable to use as little energy as possible. In particular when heating in winter, i.e. when it is cold outside, unlike with vehicles that have an internal combustion engine, there is very little exhaust heat that can be used. To nevertheless be able to reduce power consumption, as much recirculated air from the passenger compartment is ideally used, even in winter. This is limited, however, because the passengers generate condensation, which accumulates on the windows in the recirculating mode.

In general, a dehumidifier is incorporated downstream of a fan in the air conditioner, if there is enough space. It may also not be possible to place a filter in front of the dehumidifier, which may result in unfiltered air flowing through it, thus clogging it, such that it breaks down or at least becomes less effective.

The present invention addresses the problem of creating a better, or at least different, design for such an air conditioner, which can be operated reliably over a long period of time, while also conserving energy.

This problem is solved with the invention by the subject matter of the independent Numbered Paragraph 1. Advantageous embodiments are the subject matter of the dependent Numbered Paragraphs.

The present invention is based on the general idea of only placing a dehumidifier in a recirculating air channel, and a filter in a subsequent mixed air channel, such that only filtered air, specifically filtered mixed air, flows through all of the components downstream of the filter, e.g. a fan, an evaporator, or a heater, while unfiltered air can flow through the dehumidifier in the recirculating air channel, because the air taken from the passenger compartment has already been filtered when it first entered and is therefore less polluted than the fresh air from outside. Furthermore, by separating the airflows, i.e. by placing the dehumidifier in the recirculating air channel, which dehumidifies this recirculating air, such that in particular in cold weather, the portion of recirculated air can be increased, the air conditioner can be operated more energy-efficiently, without concerns regarding a greater likelihood that the windows will fog up.

The air conditioner for a motor vehicle obtained with the invention has at least the following components: a fresh air channel and a recirculating air channel, with a mixed air channel downstream thereof. There is a fan in the mixed air channel that conveys the air flowing therein. There are also an evaporator and a heater for cooling or heating the mixed air in the mixed air channel. The aforementioned dehumidifier is in the mixed air channel, and there is at least one filter downstream of the dehumidifier. This results in a particularly compact air conditioner, because the dehumidifier, fan, filter, evaporator, and heater are preferably inside the same housing. Moreover, the dehumidifier will continue to function for a long time, because it is in the recirculating air channel, and only previously filtered air from the passenger compartment flows through it. The filter downstream of the dehumidifier in the mixed air channel filters mixed air, thus reliably keeping the fan, heater and evaporator clean. It is understood that the filter system can contain a single filter in the mixed air channel, or numerous filters at different places in the mixed air channel.

The filter in the mixed air channel is downstream or upstream of the fan. If the filter is upstream of the fan, it can filter the mixture of recirculated air and fresh air prior to it passing through the fan. This filtered mixed air then flows through the evaporator and the heater, such that they are also kept at least fairly clean. There could also be at least two such filters in the mixed air channel, upstream and downstream of the fan, resulting in a significantly more effective filtering, by refiltering the mixed air in the second filter, after it has already been filtered by the first. These filters can also be made of different materials, e.g. to filter out pollen, pollutants, hydrocarbons, etc.

The evaporator in the air conditioner can preferably be upstream of the heater. The mixed air supplied to the passenger compartment is then cooled when it passes through the active evaporator, which can also be switched off if this mixed air does not need to be cooled.

In a preferred design of the air conditioner obtained with the invention, there is at least one first bypass channel for the heater, with a first regulator that divides a mixed airflow between the heater and the first bypass channel. Consequently, it is possible to bypass the heater, thus reducing pressure losses in the air conditioner when only cooled mixed air is to be supplied to the passenger compartment. It is also possible to switch off the heater when only cooled air is to be supplied to the passenger compartment, in which case the mixed air could flow through it. By diverting the mixed air through the bypass channel, thus circumventing the heater, pressure losses in the air conditioner can be reduced, thus increasing the efficiency of the air conditioner.

The first regulator contains a slider or a shutter. This makes it relatively easy to direct the mixed airflow to either the heater or the first bypass channel, resulting in a particularly effective air conditioning of the passenger compartment.

In another advantageous embodiment of the air conditioner obtained with the invention, there is at least one second bypass channel for the heater in the mixed air channel, which has a second regulator for dividing the mixed air flow between the heater and the second bypass channel. In this case, there are bypass channels on both sides of the heater, and the first and second regulators can basically arbitrarily divide the mixed airflow between the first bypass channel, the heater, and the second bypass channel. If the mixed air supplied to the passenger compartment is to be heated, the first and second regulators close off the first and second bypass channels, such that all of the mixed air flows through the heater. If the mixed air is not to be heated, the first and second regulators open the first and second bypass channels, such that the air flows around the heater with little pressure loss. This second regulator can also contain a slider or a shutter.

In another advantageous embodiment of the air conditioner obtained with the invention, there is a connection between the recirculating air channel and the fresh air channel upstream of the dehumidifier, through which recirculated air can be diverted into the fresh air channel, thus circumventing the dehumidifier. This connection can be opened or closed with a slider or shutter, depending on the moisture content in the recirculated air, such that if this air is relatively dry, it does not pass through the dehumidifier in the recirculating air channel, and instead is diverted into the fresh air channel, thus circumventing the dehumidifier with little pressure loss. This may be the case, for example, if there is only one passenger in the passenger compartment, who generates little condensation. The extent to which this connection between the recirculating air channel and the fresh air channel is opened can be controlled by a control unit connected to a moisture sensor in the recirculating air channel.

The mixed air channel is connected to air vents, defrost vents, footwell vents and/or rear vents. This makes it possible to concentrate the air flow in different areas in the passenger compartment, e.g. to defrost the windshield. This is not a conclusive list, and there can also be other vents connected to the mixed air channel.

The present invention is also based on the general idea of equipping a motor vehicle with the air conditioner described above, thus obtaining the same advantages for the vehicle obtained with the invention. These advantages result in a compact air conditioner. By integrating the dehumidifier in the air conditioner, and using a relatively high proportion of recirculated air, the power consumption of the air conditioner can be significantly reduced, even in cold weather. By placing the dehumidifier only in the recirculating air channel, pressure losses when flowing through the dehumidifier are lower than when the dehumidifier is placed in the mixed air channel with an upstream filter. If the dehumidifier is placed in the recirculating air channel, it can be smaller and less expensive. Moreover, the air in the fresh air channel often does not need to be dehumidified, because it is usually less humid than the air in the passenger compartment.

The motor vehicle is ideally an electric vehicle. Winter is particularly critical, because it requires a lot of electricity to heat the passenger compartment, which has a negative impact on the travel range of the electric vehicle. By placing the dehumidifier in the recirculating air channel, more recirculated air can be returned to the passenger compartment in winter, thus significantly reducing the amount of electricity needed for heating, because this recirculated air is already substantially warmer than the outside air. The travel range of the electric vehicle can thus be increased with this air conditioner, without the risk of the windows fogging up.

Other features and advantages of the invention can be derived from the dependent Numbered Paragraphs, the drawing, and the descriptions of the drawing.

It is understood that the features specified above and explained below can be used not only in the given combinations, but also in other combinations or in and of themselves, without abandoning the scope of protection for the present invention. Components of a higher order unit, e.g. an element, device, or assembly, that are indicated separately, can be separate components of this unit, or integral parts or sections thereof, even if the drawing indicates otherwise.

A preferred embodiment of the invention is shown in the drawing, and shall be explained in greater detail below.

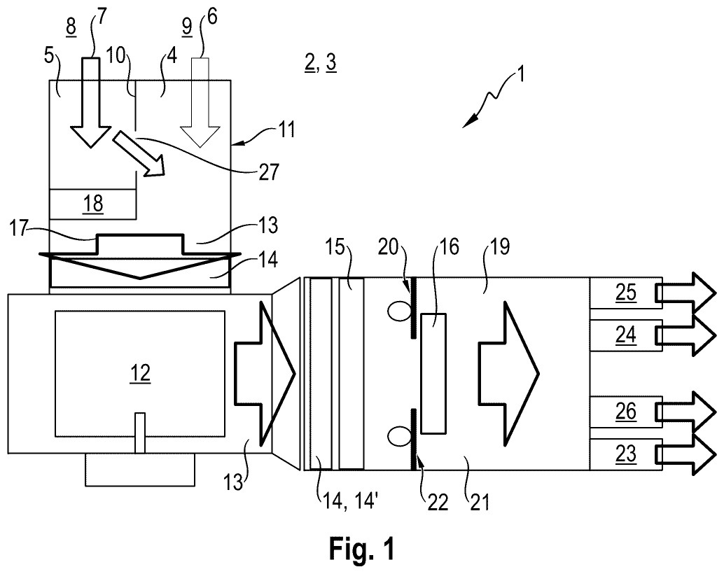

The single FIG. 1 shows a sectional view of an air conditioner obtained with the invention, in a motor vehicle obtained with the invention.

The air conditioner 1 in FIG. 1 for a motor vehicle 2, in particular an electric vehicle 3, contains at least the following: a fresh air channel 4 and a recirculating air channel 5, in which fresh air flows through the fresh air channel 4 and recirculated air flows through the recirculating air channel 5. The recirculated air 7 is taken from the passenger compartment 8, and the fresh air 6 is from the exterior 9. There is a separating wall 10 between the fresh air channel 4 and the recirculating air channel 5, which can be part of a housing 11. The housing can be a plastic injection molded part.

There is a mixed air channel 13 downstream of the fresh air channel 4 and the recirculating air channel 5, which contains a fan 12.

The mixed air channel 13 also contains a filter 14, an evaporator 15, and a heater 16. Mixed air 17 can be filtered in the filter 14, which can be upstream of the fan 12. This filter 14, or a secondary filter 14′ can also be downstream of the fan 12, i.e. between it and the evaporator 15. There is also a dehumidifier 18 in the recirculating air channel 15, at the end thereof, as shown in FIG. 1. The filter 14 is therefore downstream of the dehumidifier 18, and upstream of the fan 12 in the mixed air channel 13.

Because the dehumidifier 18 is only in the recirculating air channel 5, the recirculated air 7 flowing through the dehumidifier 18 does not need to be filtered, because it comes from the passenger compartment 8, and has already been filtered.

FIG. 1 also shows that the evaporator 15 is upstream of the heater 16, and the dehumidifier 18 is also upstream of the evaporator 15.

There is also a first bypass channel 19 circumventing the heater 16 in the mixed air channel 13, which has a regulator 20 that can divide the mixed air flow between the heater 16 and the first bypass channel 19. This first regulator 20 can contain a slider, as shown in FIG. 1, or a shutter that can be pivoted or rotated.

There is also a second bypass channel 21 that circumvents the heater 16 in the mixed air channel 13, which has a second regulator 22 for dividing the mixed air flow 17 between the heater 16 and the second bypass channel 21. The entire mixed air flow 17 can be directed through the heater 16 or the two bypass channels 19, 21, depending on the settings of the two regulators 20, 22. If there is no need for heated air in the passenger compartment 8, the regulators 20, 22 can open the two bypass channels 19 and 21, and close the heater 16, such that the air can circumvent the heater 16 with little pressure loss. The regulators 20, 22 can also be partially opened or closed, such that a portion of the mixed air 17 flows through at least one of the bypass channels 19, 21, and the rest flows through the heater 16.

The mixed air channel 13 is connected to rear vents 23, air vents 24, defrosting vents 25, and footwell vents 26.

There can be a connection 27 in the separating wall 10 that separates the fresh air channel 4 from the recirculating air channel 5 upstream of the dehumidifier 18, through which recirculated air 7 can be diverted into the fresh air channel 4, thus circumventing the dehumidifier 18. If, for example, the recirculating mode is preferred, in particular in a tunnel, but the recirculated air 7 does not need to be dehumidified, this connection 27 can be opened to reduce pressure losses, and thus simply circumvent the dehumidifier 18.

A compact and inexpensive air conditioner 1 can be obtained with the invention, because the dehumidifier 18 is only in the recirculating air channel 5 and can therefore be smaller and less expensive. Because the recirculated air 7 from the passenger compartment 8 already flows through the dehumidifier 18, it does not need to be filtered, and the filter 14 in the air conditioner 1 can thus be downstream of the dehumidifier 18. As a result of the dehumidifier 18 in the recirculating air channel 5, more recirculated air can be used to heat the passenger compartment 8 in winter, thus reducing power consumption and increasing the travel range of the vehicle 2, in particular if it is an electric vehicle 3, because the recirculated air 7 is normally warmer than the fresh air 6 from the exterior 9.

The specification can be readily understood with reference to the following Numbered Paragraphs:
Numbered Paragraph 1. An air conditioner (1) for a motor vehicle (2), characterized in that the air conditioner (1) has at least the following components:
   a fresh air channel (4) and a recirculating air channel (5), as well as a downstream mixed air channel (13),
   a fan (12) for conveying the mixed air (17) in the mixed air channel (13),
   an evaporator (15) for cooling the mixed air (17) in the mixed air channel (13),
   a heater (16) for heating the mixed air (17) in the mixed air channel (13),
   a dehumidifier (18) for dehumidifying recirculated air (7) in the recirculating air channel (5),
   at least one filter (14) downstream of the dehumidifier (18) in the mixed air channel (13).
Numbered Paragraph 2. The air conditioner (1) according to Numbered Paragraph 1, characterized in that
   the filter (14) in the mixed air channel (13) is upstream or downstream of the fan (12), or
   there are two filters (14, 14′) in the mixed air channel (13) upstream and downstream of the fan (12).
Numbered Paragraph 3. The air conditioner (1) according to Numbered Paragraph 1 or 2, characterized in that the evaporator (15) is upstream of the heater (16).
Numbered Paragraph 4. The air conditioner (1) according to any of the preceding Numbered Paragraphs, characterized in that the dehumidifier (18) is upstream of the evaporator (15).
Numbered Paragraph 5. The air conditioner (1) according to any of the preceding Numbered Paragraphs, characterized in that there is at least one first bypass channel (19) in the mixed air channel (13) for circumventing the heater (16), with a first regulator (20) that divides the mixed air (17) between the heater (16) and the first bypass channel (19).
Numbered Paragraph 6. The air conditioner (1) according to Numbered Paragraph 5, characterized in that the first regulator (20) contains a slider or a shutter.
Numbered Paragraph 7. The air conditioner (1) according to any of the preceding Numbered Paragraphs, characterized in that there is at least one second bypass channel (21) in the mixed air channel (13) for circumventing the heater (16), with a second regulator (22) that divides the mixed air (17) between the heater (16) and the second bypass channel (21).
Numbered Paragraph 8. The air conditioner (1) according to Numbered Paragraph 7, characterized in that the second regulator (22) contains a slider or a shutter.
Numbered Paragraph 9. The air conditioner (1) according to any of the preceding Numbered Paragraphs, characterized in that the mixed air channel (13) is connected to air vents (24), defrost vents (25), footwell vents (26), and/or rear vents (23).
Numbered Paragraph 10. The air conditioner (1) according to any of the preceding Numbered Paragraphs, characterized in that there is a connection (17) between the recirculating air channel (5) and the fresh air channel (4) upstream of the dehumidifier (18), with which recirculated air (7) can be diverted into the fresh air channel (4) to circumvent the dehumidifier (18).
Numbered Paragraph 11. A motor vehicle (2) that has a passenger compartment (8) and an air conditioner (1) according to any of the preceding Numbered Paragraphs.
Numbered Paragraph 12. The motor vehicle according to Numbered Paragraph 11, characterized in that the motor vehicle (2) is an electric vehicle (3).

List of Reference Symbols

| | |
|---|---|
| 1 | air conditioner |
| 2 | motor vehicle |
| 3 | electric vehicle |
| 4 | fresh air channel |
| 5 | recirculating air channel |
| 6 | fresh air |
| 7 | recirculated air |
| 8 | passenger compartment |
| 9 | exterior |
| 10 | separating wall |
| 11 | housing |
| 12 | fan |
| 13 | mixed air channel |
| 14 | filter |
| 15 | evaporator |
| 16 | heater |
| 17 | mixed airflow |
| 18 | dehumidifier |
| 19 | first bypass channel |
| 20 | first regulator |
| 21 | second bypass channel |
| 22 | second regulator |
| 23 | rear vents |
| 24 | air vents |
| 25 | defrost vents |
| 26 | footwell vents |
| 27 | connection |

1-12. (canceled)

13. An air conditioner for a motor vehicle, comprising at least the following components:
a fresh air channel and a recirculating air channel, and a downstream mixed air channel,
a fan configured for conveying the mixed air in the mixed air channel,
an evaporator configured for cooling the mixed air in the mixed air channel,
a heater configured for heating the mixed air in the mixed air channel,
a dehumidifier configured for dehumidifying recirculated air in the recirculating air channel,
at least one filter downstream of the dehumidifier in the mixed air channel.

14. The air conditioner according to claim 13, wherein the at least one filter in the mixed air channel is upstream or downstream of the fan, or the at least one filter comprises a first filter and a second filter in the mixed air channel wherein the first filter is disposed upstream of the fan and the second filter is disposed downstream of the fan.

15. The air conditioner according to claim 13, wherein the evaporator is upstream of the heater.

16. The air conditioner according to claim 13, wherein the dehumidifier is upstream of the evaporator.

17. The air conditioner according to claim 13, further comprising at least one first bypass channel in the mixed air channel, the at least one first bypass channel is configured for circumventing the heater, and further comprising a first regulator that is configured to divide the mixed air between the heater and the first bypass channel.

18. The air conditioner according to claim 17, wherein the first regulator comprises a slider or a shutter.

19. The air conditioner according to claim 13, further comprising at least one second bypass channel in the mixed air channel, the second bypass channel is configured for circumventing the heater, and further comprising a second regulator that is configured to divide the mixed air between the heater and the second bypass channel.

20. The air conditioner according to claim 19, wherein the second regulator comprises a slider or a shutter.

21. The air conditioner according claim 13, wherein the mixed air channel is connected to one or more of air vents, defrost vents, footwell vents, and/or rear vents of a vehicle that includes the air conditioner.

22. The air conditioner according to claim 13, further comprising a connection between the recirculating air channel and the fresh air channel upstream of the dehumidifier, with which recirculated air can be diverted into the fresh air channel to circumvent the dehumidifier.

23. A motor vehicle comprising has a passenger compartment and an air conditioner according to claim 14.

24. The motor vehicle according to claim 23, wherein the motor vehicle is an electric vehicle.
